(19) United States
(12) Patent Application Publication
(10) Pub. No.: US 2005/0289582 A1
(43) Pub. Date: Dec. 29, 2005

(54) System and method for capturing and using biometrics to review a product, service, creative work or thing

(75) Inventors: Clifford Tavares, San Jose, CA (US); Toshiyuki Odaka, Tokyo (JP)

Correspondence Address: SQUIRE, SANDERS & DEMPSEY L.L.P, 600 HANSEN WAY, PALO ALTO, CA, 94304-1043, US

(73) Assignee: Hitachi, Ltd., Tokyo (JP)

(21) Appl. No.: 10/876,848

(22) Filed: Jun. 24, 2004

(51) Int. Cl. H04H 9/00; G06K 9/00; H04N 7/16

(52) U.S. Cl. 725/10; 382/115

(57) ABSTRACT

A system enables capturing biometric information while a user is perceiving a particular product, service, creative work or thing. For example, while movie-goers watch a movie, the system can capture and recognize the facial expressions, vocal expressions and/or eye expressions (e.g., iris information) of one or more person's in the audience to determine an audience's reaction to movie content. Alternatively, the system could be used to evaluate an audience's reaction to a public spokesman, e.g., political figure. The system could be useful to evaluate consumer products or story-boards before substantial investment in movie development occurs. Because these biometric expressions (laughing, crying, etc.) are generally universal, the system is generally independent of language and can be applied easily for global-use products and applications. The system can store the biometric information and/or results of any analysis of the biometric information as the generally true opinion of the particular product, service, creative work or thing, and can then enable other potential users of the product to review the information when evaluating the product.

### BACKGROUND OF THE INVENTION

1. Field of the Invention

This invention relates generally to biometrics, and more particularly provides a system and method for capturing and using biometrics to review a product, service, creative work or thing.

2. Description of the Background Art

Consumers often select videos, theatrical shows, movies and television programming based on consumer reviews, such as those provided by film critics like Roger Ebert, those published in newspapers like the New York Times, those posted on websites like “amazon.com,” and/or those generated from research like that conducted by Nielsen Media Research.

For example, film critics (whether through television or newspaper media) offer only personal opinion, opinion which is often fraught with personal bias. If a particular critic does not like horror films, the particular critic is less likely to give a horror film a good rating. Similarly, if a particular critic enjoys action movies or is attracted to certain movie stars, then the critic may be more likely to give action movies or shows with his or her favorite movie stars higher ratings.

The majority of movie-goers do not typically post their opinions or rate each movie. Thus, only a limited number of opinions is typically available. Further, one tends to expect only web junkies (i.e., those with a fetish to post opinions about everything) and extremists (i.e., those with unusually strong opinions either in favor or against) to post opinions on such websites. Accordingly, in this case, consumers either cannot obtain enough postings to determine the public's opinion or cannot trust the opinions posted as accurate.

Nielsen Media Research collects viewing information automatically based on the television channels set by the Nielsen audience. Although the Nielsen audience is fairly large (around 5,000 households and 11,000 viewers) and of varying ethnicities and geographies, the ratings are not qualitative. Since the Nielsen system relies only on the television channel set, the data collected does not indicate whether the audience is actually watching or enjoying the show. Thus, since these ratings do not provide qualitative measurements, these ratings do not provide an accurate review of public opinion of particular programming.

Therefore, a system and method are needed that provide more accurate, qualitative feedback about a product, service, creative work or thing and that preferably do not suffer from the above drawbacks.

### SUMMARY

An embodiment of the present invention includes a system for capturing biometric information while a user is perceiving a particular product, service, creative work or thing. For example, while movie-goers watch a movie, the system can capture and recognize the facial expressions, vocal expressions and/or eye expressions (e.g., iris information) of one or more person's in the audience to determine an audience's reaction to movie content. Alternatively, the system could be used to evaluate an audience's reaction to a public spokesman, e.g., political figure. The system could be useful to evaluate consumer products or story-boards before substantial investment in movie development occurs. Because these biometric expressions (laughing, crying, etc.) are generally universal, the system is generally independent of language and can be applied easily for global-use products and applications.

The system can interpret the biometric information to determine the human emotions and/or emotional levels (degree or probability) as feedback or reaction to the product, service, creative work or thing. The system can store the feedback in a feedback database for future consumption, and can provide the biometric information and/or results of any analysis of the biometric information as the generally true opinion of the particular product, service, creative work or thing to other potential users (e.g., consumers, viewers, perceivers, etc.). That way, other potential users can evaluate public opinion more accurately. In a cyclical fashion, when a new user selects a particular product, service, creative work or thing based on the feedback, the new user's reaction to the product, service, creative work or thing can be captured and added to the feedback database.

As is readily apparent to most, generally, a smile without laughter may be interpreted as happiness. A simultaneous smile with laughter may be interpreted that a person finds something particularly funny. A simultaneous smile with laughter and tears may be interpreted that a person finds something extremely funny and is laughing rather hysterically. Further, as is readily apparent, the amount of laughter, the size and duration of the smile, the amount of tears can be used to determine how funny a person finds the product, service, creative work or thing.

Similarly, as is readily apparent, tears without the sounds of crying suggest sadness or fatigue. Tears with a crying sound suggest sadness. In a similar way to happiness, the amount and/or duration of tearing, the loudness and/or duration of the crying, etc. may be used to determine a person's level of sadness. On the other hand, a crying sound without a change in facial expression may suggest that a person is just pretending to be sad.

Continuing with some further examples, a quickly changing facial expression and/or a sharp exclamation of vocal sound such as a scream may suggest surprise. However, it will be appreciated that some persons react to surprising events without sound and some persons may not react for a while until the surprising events are processed. Iris biometrics may assist in the determination of shock and surprise.

Generally, any algorithms for translating the facial expressions, vocal expressions and eye expressions into emotions and/or emotional levels can be used to implement the embodiments of the present invention. For example, Hidden Markov Models, neural networks or fuzzy logic may be used. The system may capture only one biometric to reduce the cost of the entire system or may capture multiple biometrics to determine human emotions and emotional levels more precisely. Further, although the systems and methods are being described with reference to viewer opinions on movies, one skilled in the art will recognize that the systems and methods can be used on anything, e.g., products, services, creative works, things, etc.

Embodiments of the invention can provide:

An automatic mechanism to obtain audience feedback;

An emotion reaction integrator for combining multiple biometrics for emotion recognition;

Metrics to help a user determine a product rating;

A cost effective mechanism of collecting marketing data; and

A mechanism more accurate than current rating mechanisms.

The present invention provides a system for capturing and using biometric information to review a product, service, creative work or thing. The system comprises information about a product, a biometric capturing device configured for capturing biometric data of a person while the person is perceiving the product, and a device for storing information based on the biometric data and the information about the product.

The product may be a video clip. The information about the product may be a video index or the product itself. The biometric data may include primary biometric data or secondary biometric data. The biometric data may include facial expressions, voice expressions, iris information, body language, perspiration levels, heartbeat information, unrelated talking, or related talking. The biometric capturing device may be a microphone, a camera, a thermometer, a heart monitor, an MRI device, or combinations of these devices. The biometric capturing device may also include a biometric expression recognizer. The information based on the biometric data may be primary biometric information, secondary biometric information, or reaction review metric information. The system may also include a decision mechanism and reaction integrator for interpreting biometric data as emotions, an advertising estimator for estimating a cost of an advertisement based on the biometric data, and/or a reviewer for enabling another person to review the information based on the biometric data and the information about the product.

The present invention further provides a method for capturing and using biometric information to review a product, service, creative work or thing. The method comprises capturing biometric information while a person perceives a product, and storing information based on the biometric information and information about the product in a database for future consumption.

### BRIEF DESCRIPTION OF THE DRAWINGS

FIG. 1 is a block diagram illustrating an emotional reaction recognizer in accordance with an embodiment of the present invention;

FIG. 2 is a block diagram illustrating an emotional reaction recognizer and storage system in accordance with an embodiment of the present invention;

FIG. 3 is a block diagram illustrating an emotional reaction recognizer, storage and evaluation network system in accordance with an embodiment of the present invention;

FIG. 4 is a block diagram illustrating an emotional reaction recognizer, storage and evaluation network system in accordance with a second embodiment of the present invention;

FIG. 5 is a block diagram illustrating a computer system in accordance with a first embodiment of the present invention;

FIG. 6 is a flowchart illustrating a method of using and capturing biometric data to evaluate a product, service, creative work or thing and to populate a consumer opinion database in accordance with an embodiment of the present invention;.

FIG. 7 is a block diagram illustrating a contents providing system;

FIG. 8 is an example of stored data in the database;

FIG. 9 is a diagram illustrating a data process of the terminal and the server; and

FIG. 10 is an example of a table of biometric data provided to user.

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

An embodiment of the present invention includes a system for capturing biometric information while a user is perceiving a particular product, service, creative work or thing. For example, while movie-goers watch a movie, the system can capture and recognize the facial expressions, vocal expressions and/or eye expressions (e.g., iris information) of one or more person's in the audience to determine an audience's reaction to movie content. Alternatively, the system could be used to evaluate an audience's reaction to a public spokesman, e.g., political figure. The system could be useful to evaluate consumer products or story-boards before substantial investment in movie development occurs. Because these biometric expressions (laughing, crying, etc.) are generally universal, the system is generally independent of language and can be applied easily for global-use products and applications.

The system can interpret the biometric information to determine the human emotions and/or emotional levels (degree or probability) as feedback or reaction to the product, service, creative work or thing. The system can store the feedback in a feedback database for future consumption, and can provide the biometric information and/or results of any analysis of the biometric information as the generally true opinion of the particular product, service, creative work or thing to other potential users (e.g., consumers, viewers, perceivers, etc.). That way, other potential users can evaluate public opinion more accurately. In a cyclical fashion, when a new user selects a particular product, service, creative work or thing based on the feedback, the new user's reaction to the product, service, creative work or thing can be captured and added to the feedback database.

Several techniques have been developed for translating biometric expressions into emotions and/or emotional levels. Y. Ariki et al., “Integration of Face and Speaker Recognition by Subspace Method,” International Conference on Pattern Recognition, pp. 456-460, 1996; Prof. Rosalind W. Picard, “Combination of Face and Voice” in the book “Affective Computing,” pp. 184-185, published by MIT Press in 1997; and Lawrence S. Chen et al., “Multimodal Human Emotion/Expression Recognition,” 3rd International Conference on Face and Gesture Recognition, pp. 366-371, 1998, each found that the two modalities, namely, speech and facial expression, were complementary. By using both speech and facial expressions, the research scientists show it possible to achieve greater emotion recognition rates than either modality alone. Their emotional categories researched consisted of happiness, sadness, anger, dislike, surprise and fear.

W. A. Fellenz et al, “On emotion recognition of faces and of speeches using neural networks, fuzzy logic and the ASSESS system,” International Joint Conference on Neural Networks, 2000, propose a framework for processing facial image sequences and speech to recognize emotional expression. Their six targeted expressions consisted of anger, sadness, joy, disgust, fear and surprise.

Uyanage C. De Silva and Pel Chi Ng, “Bimodal Emotion Recognition,” 4th International Conference on Automatic Face and Gesture Recognition, 2000, describe the use of statistical techniques and Hidden Markov Models (HMM) to recognize emotions. Their techniques aim to classify the six basic emotions, namely, anger, dislike, fear, happiness, sadness and surprise, from both facial expressions (video) and emotional speech (audio). They show that audio and video information can be combined using a rule-based system to improve the emotion recognition rate.

Japanese Patent TOKU-KAI-HEI 6-67601 of Hitachi Ltd. describes a sign language translator that recognizes sign language from hand movement and recognizes emotions and its probabilities from just facial expressions.

As is readily apparent to most, generally, a smile without laughter may be interpreted as happiness. A simultaneous smile with laughter may be interpreted that a person finds something particularly funny. A simultaneous smile with laughter and tears may be interpreted that a person finds something extremely funny and is laughing rather hysterically. Further, as is readily apparent, the amount of laughter, the size and duration of the smile, the amount of tears can be used to determine how funny a person finds the product, service, creative work or thing.

Similarly, as is readily apparent, tears without the sounds of crying suggest sadness or fatigue. Tears with a crying sound suggest sadness. In a similar way to happiness, the amount and/or duration of tearing, the loudness and/or duration of the crying, etc. may be used to determine a person's level of sadness. On the other hand, a crying sound without a change in facial expression may suggest that a person is just pretending to be sad.

Continuing with some further examples, a quickly changing facial expression and/or a sharp exclamation of vocal sound such as a scream may suggest surprise. However, it will be appreciated that some persons react to surprising events without sound and some persons may not react for a while until the surprising events are processed. Iris biometrics may assist in the determination of shock and surprise.

Generally, any algorithms for translating the facial expressions, vocal expressions and eye expressions into emotions and/or emotional levels can be used to implement the embodiments of the present invention. For example, Hidden Markov Models, neural networks or fuzzy logic may be used. The system may capture only one biometric to reduce the cost of the entire system or may capture multiple biometrics to determine human emotions and emotional levels more precisely. Further, although the systems and methods are being described with reference to viewer opinions on movies, one skilled in the art will recognize that the systems and methods can be used on anything, e.g., products, services, creative works, things, etc.

For the sake of establishing convenient language, the term “product” includes all products, services, creative works or things that can be perceived by a person. The term “person” includes any person, whether acting as a consumer, user, viewer, listener, movie-goer, political analyst, or other perceiver of a product. The term “primary biometrics” includes the physical expressions by persons perceiving a product. Such expressions include laughter, tearing, smiling, audible cries, words, etc. Such expressions may also include body language, and human-generated noises such as whistling, clapping and snapping. The term “secondary biometrics” includes the general emotions and/or emotional levels recognized from the particular expressions (whether the system is correct in its analysis or not). Such secondary biometrics include happiness, sadness, fear, anger, disgust, surprise, etc. The term “reaction review metrics” correspond to the description of a product that would generally evoke the primary and secondary biometrics. Example reaction review metrics include amount of comedy, amount of drama, amount of special effects, amount of horror, etc. It should be appreciated that the differences between primary biometrics, secondary biometrics and reaction review metrics are somewhat blurred. For example, laughter can arguably be either a primary or a secondary biometric. Funniness can arguably be a secondary biometric or a reaction review metric.

Embodiments of the invention can provide:

An automatic mechanism to obtain audience feedback;

An emotion reaction integrator for combining multiple biometrics for emotion recognition;

Metrics to help a user determine a product rating;

A cost effective mechanism of collecting marketing data; and

A mechanism more accurate than current rating mechanisms.

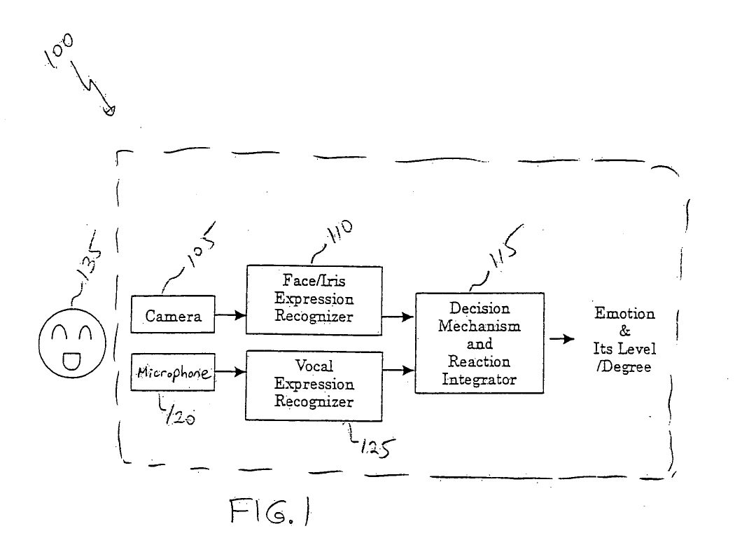

FIG. 1 is a block diagram illustrating an emotional reaction recognizer 100 in accordance with an embodiment of the present invention. The emotional reaction recognizer 100 includes a camera 105 coupled via a face/iris expression recognizer 110 to a decision mechanism and reaction integrator 115. Recognizer 100 further includes a microphone 120 coupled via a vocal expression recognizer 125 to the decision mechanism and reaction integrator 115. As illustrated, the camera 105 and microphone 120 capture biometric information from a person 135.

The camera 105 captures image information from the person 135, and for convenience is preferably a digital-type camera. However, analog-type cameras can alternative be used. The camera 105 may be focused only on the head of the person 135 to capture facial expressions and/or eye expressions (e.g., iris information), although in other embodiments the camera 105 may be focused on the body of the person 135 to capture body language. As one skilled in the art will recognize, if the camera 105 is capturing body language, then a body language recognizer (not shown) could be coupled between the camera 105 and the decision mechanism and reaction integrator 115.

The microphone 120 captures sound expressions from the person 135, and is preferably a digital-type microphone. It will be appreciated that the microphone 135 may be a directional microphone to try to capture each person's utterances individually, or a wide-range microphone to capture the utterances of an entire audience. Further, the microphone 120 may capture only a narrow band of frequencies (e.g., to attempt to capture only voice-created sounds) or a broad band of frequencies (e.g., to attempt to capture all sounds including clapping, whistling, etc).

Face/iris expression recognizer 110 preferably recognizes facial and/or eye expressions from image data captured via the camera 105 and possibly translates the expressions to emotions and/or emotional levels. Alternatively, the face/iris expression recognizer 110 can translate the expressions into emotional categories or groupings. The recognizer 110 may recognize expressions such as neutral face (zero emotion or baseline face), smiling face, medium laughter face, extreme laughter face, crying face, shock face, etc. The face/iris expression recognizer 110 can recognize iris size. Further, the face/iris recognizer 110 may recognize gradations and probabilities of expressions, such as 20% laughter face, 35% smiling face and/or 50% crying face, etc. and/or combinations of expressions.

Vocal expression recognizer 125 preferably recognizes vocal expressions from voice data captured via the microphone 120 and possibly translates the vocal expressions into emotions and/or emotional levels (or emotional categories or groupings). The voice expression recognizer 125 may recognizes laughter, screams, verbal expressions, etc. Further, the vocal expression recognizer 125 may recognize gradations and probabilities of expressions, such as 20% laughter, 30% crying, etc. It will be appreciated that the voice expression recognizer 125 can be replaced with a sound expression recognizer (not shown) that can recognize vocal expressions (like the vocal expression recognizer 125) and/or non-vocal sound expressions such as clapping, whistling, table-banging, foot-stomping, snapping, etc.

The camera 105 and microphone 120 are each an example of a biometric capturing device. Other alternative biometric capturing devices may include a thermometer, a heart monitor, or an MRI device. Each of the face/iris expression recognizer 110, the body language recognizer (not shown) and the vocal expression recognizer 125 are an example of a “biometric expression recognizer.” The camera 105 and face/iris expression recognizer 110, the camera 105 and body language recognizer (not shown), the microphone 120 and vocal expression recognizer 125 are each an example of a “biometric recognition system.”

Decision mechanism and reaction integrator 115 combines the results from the face/iris expression recognizer 110 and from the vocal expression recognizer 125 to determine the complete primary biometric expression of the person 135. The integrator 115 can use any algorithms, for example, rule-based, neural network, fuzzy logic and/or other emotion analysis algorithms to decide a person's emotion and emotional level from the primary biometric expression. Accordingly, the integrator can determine not only the emotion (e.g., happiness) but also its level, e.g., 20% happy and 80% neutral. Although not shown, the integrator 115 can associate the expressions and emotions with information on the product (e.g., movie, movie index, product identification information, political figure's speech information, etc.) being perceived. Such integration can enable other persons to relate product to emotions expected.

Although FIG. 1 is limited to facial and vocal biometric information, one skilled in the art will recognize that other biometrics and biometric combinations could be captured to determine emotions and/or emotional levels. For example, the emotional reaction recognizer 100 could capture hand gestures, heartbeat, perspiration, body language, amount of unrelated talking, etc. The decision mechanism and reaction integrator 115 can use translation algorithms to convert the primary biometric expressions (smiles, audible laughter, tears, etc.) into emotions like laughter, fear, surprise, etc. and/or corresponding levels.

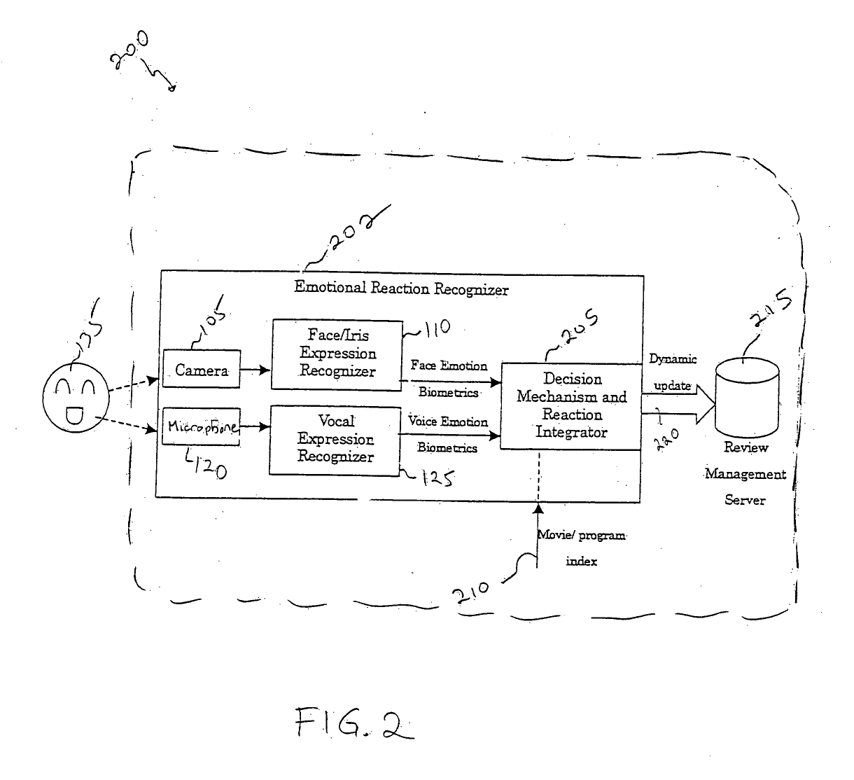

FIG. 2 is a block diagram illustrating an emotional reaction recognizer and storage system 200 in accordance with an embodiment of the present invention. The system 200 could be placed almost anywhere, e.g., in homes, theaters, airplanes and/or cars. The system 200 could be integrated in mobile devices, especially cellular phones since cellular phones tend to have both microphones and cameras. This system 200 can be integrated into televisions or set-top-boxes for home use, or into the backs of theater seats for cinematic use. The system 200 includes an emotional reaction recognizer 202, which includes the camera 105 coupled via the face/iris expression recognizer 110 to a decision mechanism and reaction integrator 205, and the microphone 120 coupled via the vocal expression recognizer 125 to the decision mechanism and reaction integrator 205. The emotional reaction recognizer 202 in turn is coupled to a review management server 215. One skilled in the art will recognize that an emotional reaction recognizer 202 may be made up of different biometric capturing device and/or device combinations, as described above with reference to FIG. 1.

The camera 105, face/iris expression recognizer 110, microphone 120 and vocal expression recognizer 125 each are similar to and operate in a similar way as the components shown in and described above with reference to FIG. 1.

The decision mechanism and reaction integrator 205 is similar to the decision mechanism and reaction integrator 115 as shown in and described above with reference to FIG. 1 with the following additions, changes and/or explanations. The integrator 205 associates the expressions, emotions and/or emotional levels with information about the product being perceived. In the embodiment of FIG. 2, the information about the product illustrated includes a movie program index 210. The integrator 205 associates the expressions, emotions and/or emotional levels with the movie content, and sends the information, shown as dynamic update information 220, to the review management server 215 for future consumption.

The review management server 215 can use the dynamic update information 220 to calculate statistical information of emotional trends as related to substantive contents. The review management server 215 can maintain the statistical information in a relational database or other structure and can provide the information 220 to interested persons (e.g., users, consumers, viewers, listeners, etc.) to show how emotional the products are and what kind of emotional reactions may be expected from perceiving the product. The review management server 215 can examine the emotions and/or emotional levels to determine reaction review metrics about the product. For example, if a movie is a comedy, the reaction review metric establishing how funny the movie was can be based on the amount of funny emotion evoked, which can be based on the amount of laughter and/or smiling expressed. Accordingly, the review management server 215 can measure and store the success of the product as a comedy. One skilled in the art will recognize that other components instead of the review management server 215, such as the decision mechanism and reaction integrator 205, can determine reaction review metrics.

In this embodiment, the server 215 can enable a new viewer to select a movie based on the dynamic update information 220, which can be presented in many different ways. For example, the server 215 may present the information as “5.5 times more laughter than average,” or “15.3 times more laugher than average, no crying.” The presentation may be in terms of primary biometrics, secondary biometrics, reaction review metrics, or combinations of them. It will be appreciated that a new viewer could become another reviewer, whether intentionally or unintentionally.

It will be appreciated that a new type of award (e.g., Academy or Grammy Award) may be determined based on the emotional fervor (e.g., statistical information) of a product (e.g., movie). In other words, the award may be based on how successful the product was relative to its emotion-evoking intent. The best comedy can be based on the greatest number of laughs expressed by its audiences.

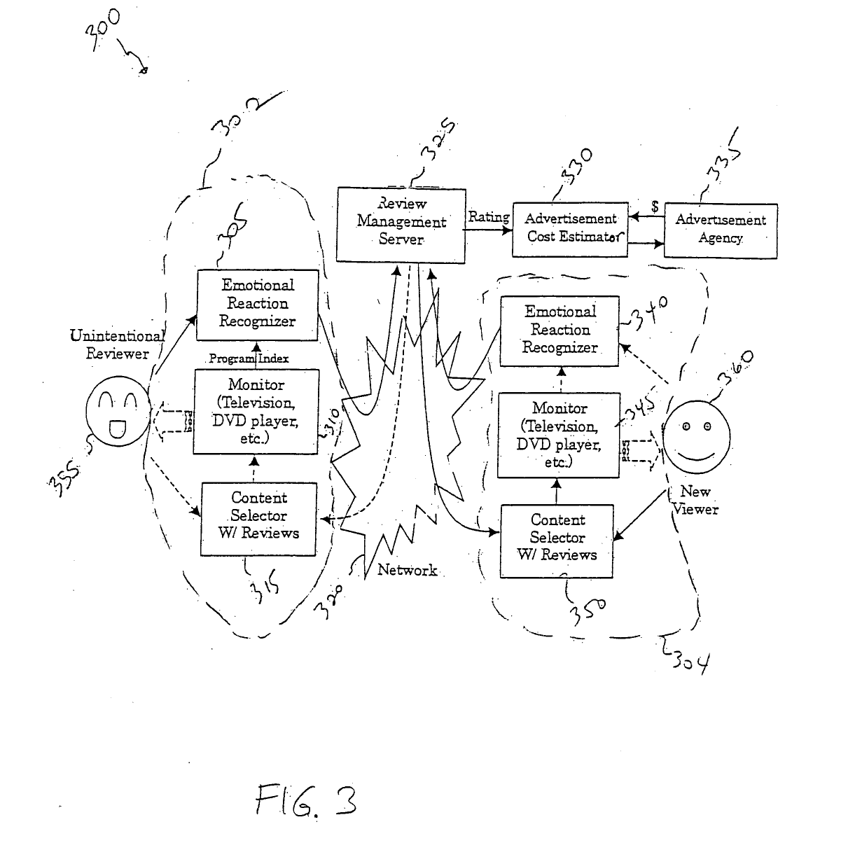

FIG. 3 is a block diagram illustrating an emotional reaction recognizer, storage and evaluation network system 300 in accordance with an embodiment of the present invention. Network system 300 includes a first content providing and biometric capturing system 302 and a second content providing and biometric capturing system 304, each coupled via a network 320 (possibly a LAN, WAN, the Internet, wireless, etc.) to a review management server 325. The review management server 325 is further coupled, possibly via network 320, to a advertisement cost estimator 330 and to an advertisement agency 335. It will be appreciated that the review management server 325 may be coupled to one or many user systems, e.g., first content providing and biometric capturing system 302 and second content providing and biometric capturing system 304.

The first content providing and biometric capturing system 302 includes a content selector with reviews 315, coupled to a monitor 310 (e.g., television, DVD player, etc.), which is coupled to an emotional reaction recognizer 305.

The content selector with reviews 315 obtains the product information and the corresponding emotional information (whether expressed as primary biometrics, secondary biometrics or reaction review metrics) from the review management server 325. The content selector with reviews 315 presents the available options to the first person 355, possibly in a list format, as a set of menu items, in hierarchical tables, or in any other fashion (preferably organized). The content selector with reviews 315 may include a conventional remote control (not shown), keyboard, touch-sensitive screen or other input device with corresponding software. The content selector with reviews 315 may include a content provider, such as a movie-on-demand service. The first person 355 can use the content selector with reviews 315 to select a product to view, e.g., a movie to watch. Although the network system 300 is being described as including the content selector with reviews 315, a person skilled in the art will recognize that any data reviewer can be used. The data reviewer enables any user to review the stored product and emotional information (possibly for selecting a product to perceive, purchase, rent, watch, control, hear, etc.).

The monitor 310 presents the selected product, e.g., movie, and may be a television or cinema screen. One skilled in the art will recognize that the monitor can be replaced or enhanced by an audio-type system if the product is music, by a tactile feed if the product is a virtual reality event, etc. The monitor 310 represents a mechanism (whether electronic or live) or mechanism combination for presenting the product.

The emotional reaction recognizer 305 captures the expressions, emotions and/or emotional levels of the first person 355. The recognizer 305 may include the components of the emotional reaction recognizer 202 as shown in and described with reference to FIG. 2.

Similar to the first content providing and biometric capturing system 302, the second content providing and biometric capturing system 304 includes a content selector with reviews 350, a monitor 345 and an emotional reaction recognizer 340 for presenting products and emotional information-to a second person 360, for collecting emotions and emotional level information to store into a database possibly maintained in the review management server 325. These components operate may be configured/programmed the same as the components in the first content providing and biometric capturing system 302. One skilled in the art will recognize that the feedback database can be maintained anywhere in the network system 300.

The review management server 325 can offer a new service providing accurate review information to users. The review information can be collected automatically, thus reducing overhead and human resources. The review management server 325 generates or updates the information in the feedback database (not shown).

The review management server 325 can send the feedback information to an advertisement cost estimator 330. Although shown in the figure as “Rating,” one skilled in the art will recognize that the information can be of any type or form. The cost estimator 330 can generate cost estimates for advertisement including television commercials for an advertisement agency 335. The better the response is for a particular product (e.g., program), the higher the estimate may be for commercials during the presentation of the product (e.g., program).

The review management server 325 preferably maintains a feedback database (not shown). Reviews may be rated using a ‘5-star’ rating scale. However, such rating scales would suffer from the disadvantages of non-statistical insufficient data, personal bias based on few receivers, poor differentiation between a moderately good and a moderately bad product, and no qualitative information for personal audience tastes. The review management server 430 preferably maintains percentage-based ratings for a broader spectrum of reactions. Some of the reaction review metrics and their relationship to secondary biometrics are shown in the table 1 below. Other metrics may also be considered.

TABLE 1
Reaction Review Metrics to Secondary Biometrics

| Reaction Review Metric | Derived from Secondary Biometric |
|---|---|
| Funny | Laughter, Crying, Happiness, Excitement |
| Thrilling | Shock, Surprise, Fear |
| Horror | Shock, Fear |
| Action/Special Effects | Excitement/Voice Exclamations |
| Dull/Boring | Yawning, Sleep |
| Interesting/Attention span | Face focused on screen |

The relationship between the two columns of the table can either be manually trained or automatically generated by using fuzzy logic to map the secondary biometrics in the reaction review matrix. For example, fuzzy rules forming a multiple fuzzy associative memory matrix (MFAMM) can be written to map the degree of fuzzy domain membership to a reaction review member score. A fuzzy domain would be a scale or dimension for each secondary biometric parameter. An MFAMM would guarantee that there exists a mapping between all combinations of ‘fuzzy domains’ and reaction review output.

The reaction review database (or feedback database) could be configured in a fashion similar to that shown in table 2 below. This table could contain a list of all programs, movies, sports, etc. being broadcast. Corresponding to each program, there could be an emotional review metric like “funny,” “thrilling,” etc. There could be a score (as a percentage or other scale) corresponding to each metric. This database can be queried on demand by users evaluating products, e.g., content. The feedback database could be automatically updated with user reaction as a user finishes experiencing a product.

TABLE 2
Example Of Reaction Review Database

| | | Action/ | Interesting/ | |
|---|---|---|---|---|
| Program | Funny | Special Effects | Attention Span | . . . |
| Movie 1: “Comedy #1” | 10% | 5% | 85% | |
| Movie 2: “Comedy #2” | 80% | 12% | 70% | |
| Movie 3 “Action #1” | 3% | 87% | 84% | |
| Sport1: “Bowling” | 1% | 5% | 3% | |
| Sport2: “Boxing” | 2% | 75% | 80% | |
| Sport3: “Football” | 2% | 60% | 70% | |
| Series 1: “Drama #1” | 40% | 65% | 56% | |
| Series 2: “Sci-Fi #1” | 10% | 72% | 61% | |
| Series 3: “Sci-Fi #2” | 25% | 50% | 80% | |

Most people would have little concern if their emotional reactions are recorded so long as no image likeness or identity information is maintained. Since the information collected for each user is parametric, the information cannot be used in identity theft or other frauds.

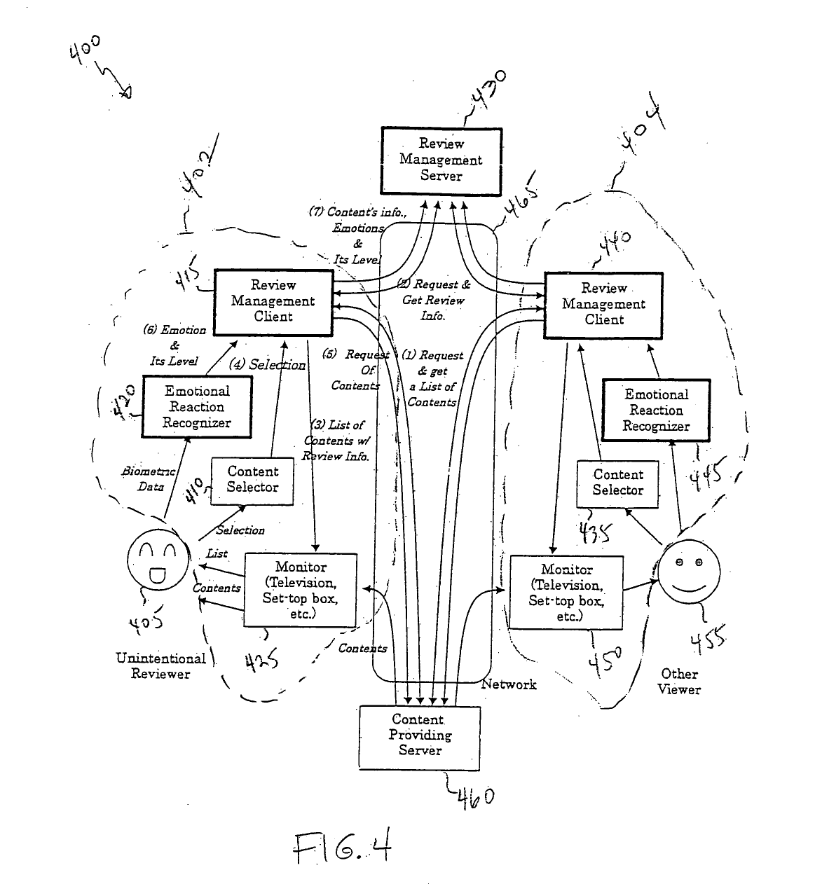

FIG. 4 is a block diagram illustrating an emotional reaction recognizer, storage and evaluation network system 400 in accordance with a second embodiment of the present invention. Although shown in the context of a movie provider, one skilled in the art will recognize that the embodiments of the invention can be used for different applications. Network system 400 includes a first content providing and biometric capturing system 402 coupled via a network 465 to a review management server 430 and a second content providing and biometric capturing system 404 coupled via the network 465 to the review management server 430. A content providing server 460 is coupled via the network 465 to the first content providing and biometric capturing system 402 and to the second content providing and biometric capturing system 404.

The first content providing and biometric capturing system 402 includes a content selector 410 coupled to a review management client 415, an emotional reaction recognizer 420 coupled to the review management client 415, and a monitor 425 coupled to the review management client 415. The review management client 415 is coupled to the review management server 430 and to the content providing server 460. The emotional reaction recognizer 420, content selector 410 and monitor 425 each act as the I/O to the first person 405, labeled in FIG. 4 as the unintentional reviewer.

In this embodiment, the second content providing and biometric capturing system 404 includes the same components coupled together in the same way as the first content providing and biometric capturing system 402. That is, the second content providing and biometric capturing system 404 includes a content selector 435 coupled to a review management client 440, an emotional reaction recognizer 445 coupled to the review management client 440, and a monitor 450 coupled to the review management client 440. The review management client 440 is coupled to the review management server 430 and to the content providing server 460. The emotional reaction recognizer 445, content selector 435 and monitor 450 each act as the I/O to the second person 455, labeled in FIG. 4 as the other viewer.

As shown by the arrows (and numbered by events) in FIG. 4, the method in this embodiment starts with the review management client 415 requesting and getting a list of the contents (or products) offered by the content providing server 460. The review management client 415 then requests and gets any review information (i.e., feedback information, whether provided as primary biometrics, secondary biometrics, or reaction review metrics) for each of the contents offered. After getting the review information, the review management client 415 provides the list of contents being offered and the corresponding review information available to the monitor 425, so that the first person 405 can peruse the information and select a content to perceive. The first person 405 then uses the content selector 410 interface to select a content for perceiving, e.g., viewing. The selection information is then sent to the review management client 415, which in turn instructs the content providing server 460 to provide the selected content to the first person 405. The content providing server 460 can then provide the content to the monitor 425 directly to the monitor 425. One skilled in the art will recognize that alternative methods are also possible without departing from the spirit and scope of the invention. For example, the user can request content directly from the content service provider 460. Further, the content provider 460 can send the content via the review management client 415 to the monitor 425.

While the user is perceiving the content, the emotional reaction recognizer 420 can monitor the first person 405 and capture biometric expressions. The emotional reaction recognizer 420 can translate the expressions into emotions and/or emotional levels, and can send the emotions and/or emotional levels associated with a content index to the review management client 415. The review management client 415 then sends the feedback information, e.g., the biometric expressions, the emotions and/or emotional levels and the content index to the review management server 430, which stores the review information for future consumption by the same or other persons 405, 455. It will be appreciated that the review management client 415 could alternatively integrate the emotions and/or emotional levels against the content index instead of the emotional reaction recognizer 420. Alternatively, only the expressions, emotions and/or emotional levels may be sent, since the review management server 430 may already know the product information or the time-based mapping. In other words, review management server 430 can easily map the expressions, emotions and/or emotional levels to the movie, since the review management server 430 may already have a mapping between the time and the movie content (e.g., an index). Many other options are also available.

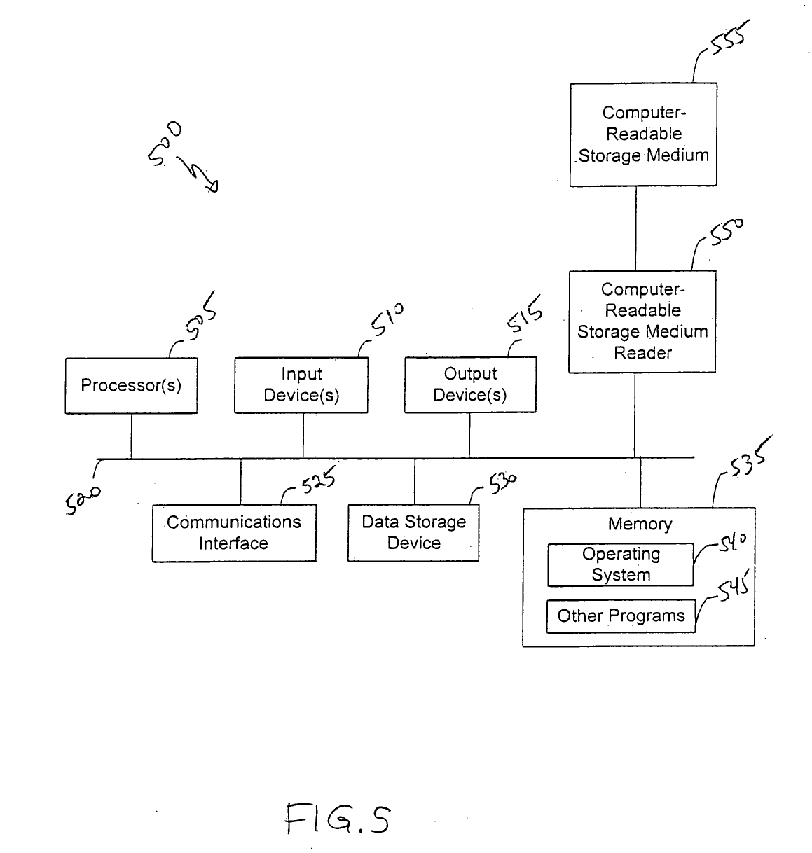

In this embodiment, we will presume that each of the review management server 430, the first content providing and biometric capturing system 402, the second content providing and biometric capturing system 404, and the content providing server 460 is maintained on a separate computer. However, one skilled in the art will recognize that each of the components or different combinations of the components and/or systems can be maintained on separate computers. For example, the review management server 430 and the content providing server 460 may be on the same computer. Also, for example, the first content providing and biometric capturing system 402 and the content providing system 460 can be on the same computer. As yet another example, the emotional reaction recognizer 420 and content review management server 430 can be on the same computer. FIG. 5 is a block diagram illustrating an example computer system 500. The computer system 500 includes a processor 505, such as an Intel Pentium® microprocessor or a Motorola Power PC® microprocessor, coupled to a communications channel 520. The computer system 500 further includes an input device 510 such as a keyboard or mouse, an output device 515 such as a cathode ray tube display, a communications device 525, a data storage device 530 such as a magnetic disk, and memory 535 such as Random-Access Memory (RAM), each coupled to the communications channel 520. The communications interface 535 may be coupled to a network such as the wide-area network commonly referred to as the Internet. One skilled in the art will recognize that, although the data storage device 530 and memory 535 are illustrated as different units, the data storage device 530 and memory 535 can be parts of the same unit, distributed units, virtual memory, etc.

The data storage device 530 and/or memory 535 may store an operating system 540 such as the Microsoft Windows NT or Windows/95 Operating System (OS), the IBM OS/2 operating system, the MAC OS, or UNIX operating system and/or other programs 545. It will be appreciated that a preferred embodiment may also be implemented on platforms and operating systems other than those mentioned. An embodiment may be written using JAVA, C, and/or C++ language, or other programming languages, along with an object oriented programming methodology. Object oriented programming (OOP) has become increasingly used to develop complex applications.

One skilled in the art will recognize that the system 500 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 550 such as a magnetic disk drive, hard disk drive, magneto-optical reader, CPU, etc. may be coupled to the communications bus 520 for reading a computer-readable storage medium (CRSM) 555 such as a magnetic disk, a hard disk, a magneto-optical disk, RAM, etc. Accordingly, the system 500 may receive programs and/or data via the CRSM reader 550. Further, it will be appreciated that the term “memory” herein is intended to cover all data storage media whether permanent or temporary.

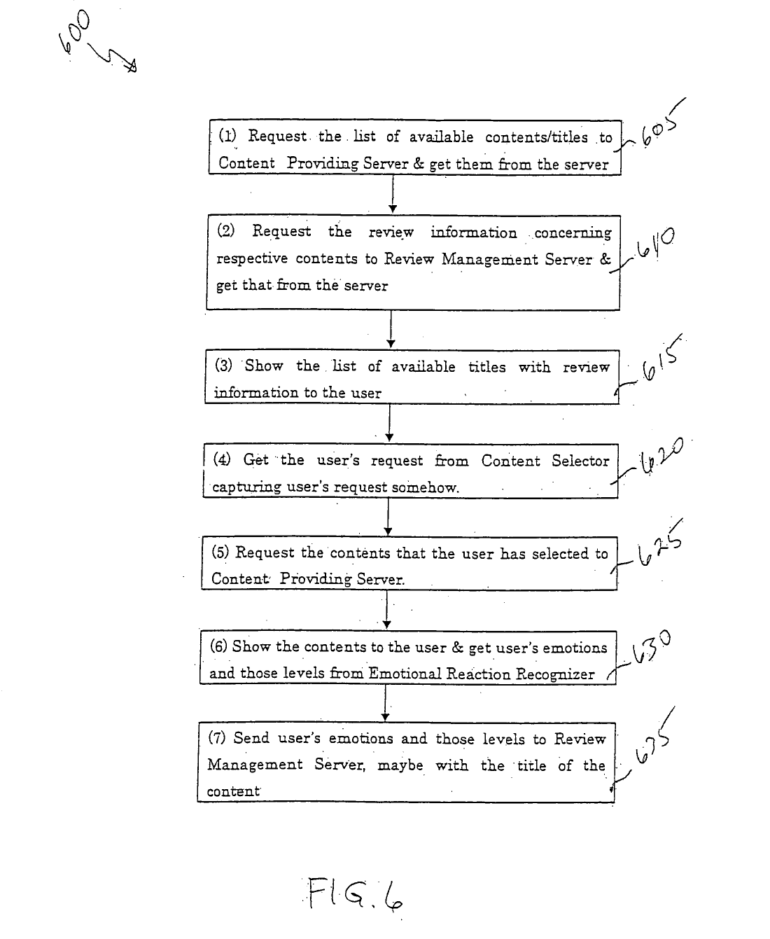

FIG. 6 is a flowchart illustrating a method 600 of using and capturing biometric data to evaluate a product and to populate a consumer opinion database in accordance with an embodiment of the present invention. Method 600 begins in step 605 by sending a request for the list of available contents/titles to the content providing server and obtaining the list from the content providing server. In step 610, a request for the review information (a.k.a., feedback, biometric or reaction information) concerning the respective contents/titles is sent to the review management server, and the review information is received from the-review management server. In step 615, the list of available contents/titles with corresponding review information is shown to the user. In step 620, the user uses the content selector to select particular content/title. The content selector can use any input capturing device, e.g., keyboard, remote control, mouse, voice command interface, touch-sensitive screen, etc. In step 625, a request for the selected content/title is sent to the content providing server. In step 630, the content is shown to the user while the user's emotions and emotional levels are captured by the emotional reaction recognizer. In step 635, the emotions and emotional levels are send to the review management server, possibly with the title of the content. Method 600 then ends.

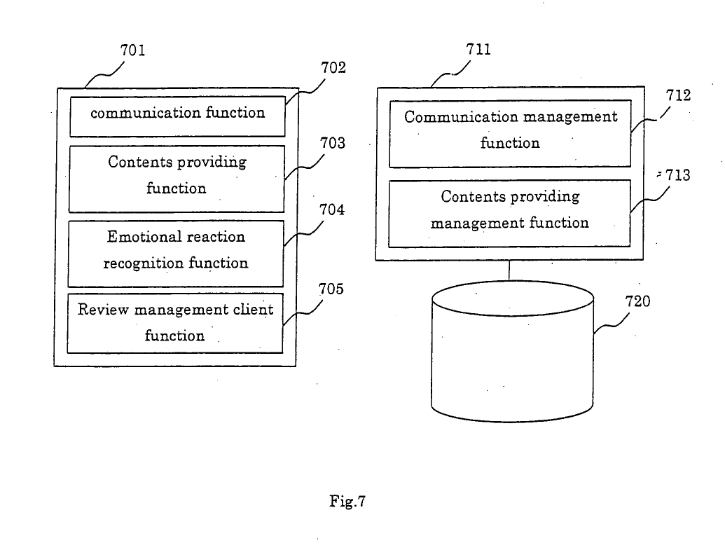

FIG. 7 shows a communication and contents service system in accordance with a third embodiment of the present invention. The communication and contents service system comprises a plurality of mobile terminals 701 and a communication and contents providing server 711. As for the communication between mobile terminals 701 and server 711, wireless communication is used.

The mobile terminal 701 has a communication function 702, and a contents providing function 703. The communication function 702 includes functions to communicate by using a voice like a cell phone, and a text data like an e-mail. The contents providing function 703 includes functions to display a movie, a TV program and sound a radio. Also the mobile terminal 701 further has an emotional reaction recognition function 704 and a review management client function 705. Basically, the function of the emotional reaction recognition function 704 includes similar components as and operates in a similar manner to the emotional reaction recognizer 420, and the review management client function 705 includes similar components as and operates in a similar manner to the review management client 415. The mobile terminal 701 has a processor, a memory, and a display device and a input device, etc., and these functions 702, 703, 704 and 705 are implemented by hardware or software. The mobile terminal 701 can store other applications in the memory for execution by the processor.

The communication and contents providing server 711 has a communication management function 712 and a contents providing management function 713. The function of the communication management function 712 manages the communication between mobile terminals 701. Also, when the server 711 receives a request for contents from the mobile terminal 701, the communication management function 712 runs the contents providing management function 713. The contents providing management function 713 includes similar components as and operates in a similar manner to the review management server 430 and the function of content providing server 460. The communication and contents providing server 711 has a processor, a memory, and a display device, etc., and these functions 712 and 713 are implemented by hardware or software.

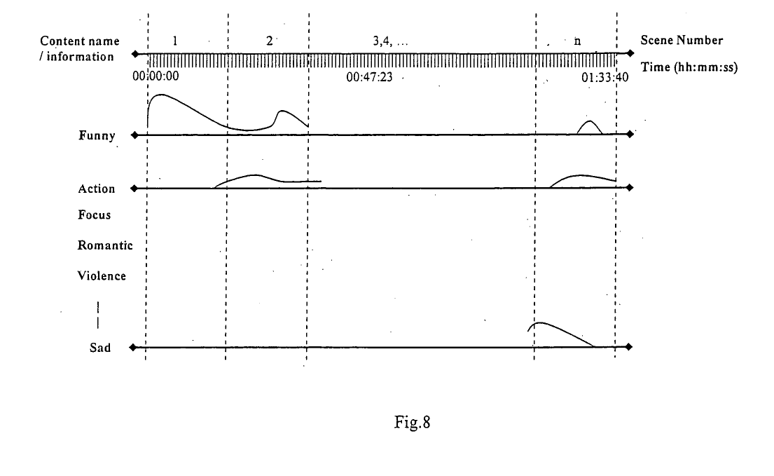

The communication and contents providing server 711 is coupled to database 720. The database 720 stores contents and a score (as a percentage or other scale) of each emotion corresponding to each contents. More specifically, the score of each emotion for predetermined time of a content is stored into the database 720 as shown in Fig. 8.

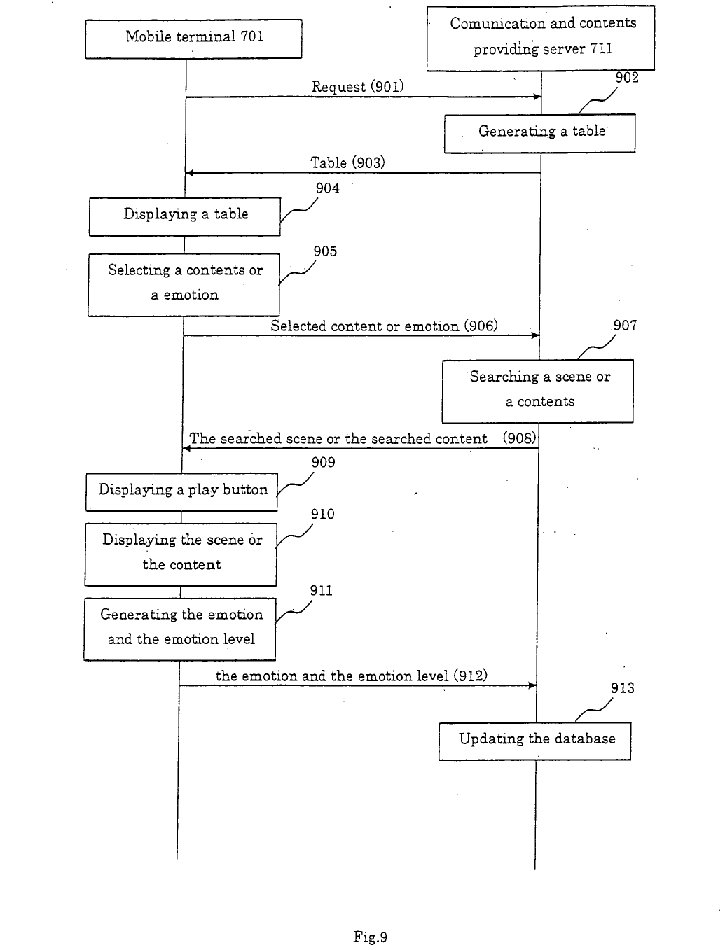

Fig. 9 shows an example of data communication between mobile terminals 701 and the communication and contents providing server 711 when the user watches or listens to content.

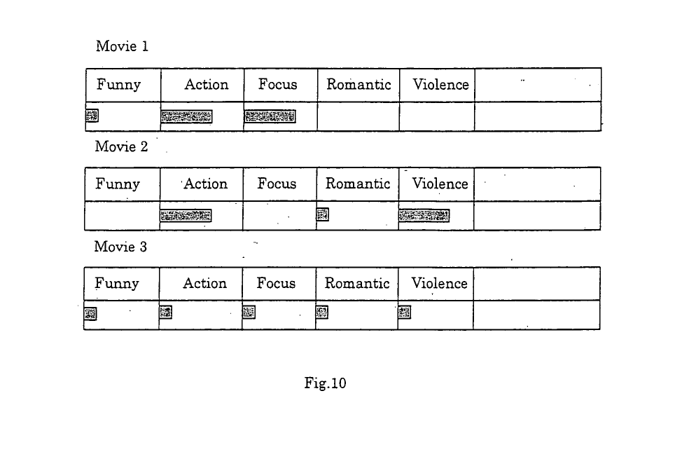

When user watches or listens to content, the user runs the contents providing function 703 of the mobile terminal 701. The contents providing function 703 runs the review management client function 705. The review management client function 705 sends a request of contents to the communication and contents providing server 711 (901). When server 711 receives the request, the communication management function 712 runs the contents providing management function 713. The contents providing management function 713 generates a table as shown in Fig. 10 (902). The table includes contents and score of each emotion for each contents based on data stored into the database 720. The score as shown in FIG. 10 shows a rate of time exceeding a predetermined score. For example, funny of movie 1 means that the time exceeding the predetermined score is 10% of the whole. The contents providing management function 713 sends the table to mobile terminal 701 (903). The mobile terminal 701 displays the table on the screen (904). The user of the mobile terminal 701 can select the content or the emotion like “funny,”, “thrilling,” etc (905). When the user selects one of the emotions, the user can watch and/or listen to the scene of the content which exceeds the predetermined level. For example, when the user selects funny which is one of the emotions, the user can watch and/or listen the funny scene of the content which exceeds the predetermined level. The review management client function 705 sends information of the content and the selected emotion to the communication and contents providing server 711 (906). The contents providing management function 713 of the server 711 searches the scene on which the selected emotion exceeds the predetermined level from the database 720 (907) and sends the searched scene to the mobile terminal 701 (908). When the review management client function 707 receives the scene, the review management client function displays a play button to play the scene on the display of the mobile terminal 701 (909).

When the user selects one of contents, the user can watch and/or listen to the content. The review management client function 705 sends information of the selected content to the communication and contents providing server 711 (906). The contents providing management function 713 of the server 711 searches the content from the database (907) and sends the searched content to the mobile terminal 701 (908). When the review management client function 707 receives the content, the review management client function 707 displays a “play button” to play the content on the display of the mobile terminal 701 (909).

When the play button is selected by the user, the review management client function 705 runs the emotional reaction recognition function 704 and displays the content on the display of the mobile terminal 701 (910). The emotional reaction recognition function 704 captures the primary biometrics. The mobile terminal 701 has a camera, a microphone and a sensor. The camera captures expressions of the user, the microphone captures voice of the user, the sensor captures strength of grip and/or sweat of the user's hand. For example, when the user is thrilled with the content, the grip becomes a strong grip and the palm becomes sweaty. The emotional reaction recognition function 704 generates the general emotions and emotional level as a secondary biometrics based on information captured by the camera, the microphone and the sensor (911). The emotional reaction recognition function 704 associates the emotion and the emotional level with the index to specify the content and the time of the content, and stores into the memory of the mobile terminal 701. The review management client function 705 reads the emotion, the emotional level, the content, and the time from the memory at intervals of predetermined time, and sends them to the communication and contents providing server 711 (912).

The contents providing management function 713 updates the score of the emotion of the database 720 based on the emotion, the emotional level, the index to specify the content and the time of the content (913). When the contents providing management function 713 receive the request, the contents providing management function 713 generates a table based on the updated score of the emotion, and sends the table to a mobile terminal 701.

In addition, advertisements with emotional information can be stored into the database 720. When the contents providing management function 713 of the server 711 receives information of the content and the selected emotion from the review management client function 705, the contents providing management function 713 searches advertisement which matches to the selected emotion, and sends the searched advertisement with the content to the mobile terminal 701. The mobile terminal display the received advertisement before displaying the content. Therefore, the system can provide advertisement according to user's emotion.

The foregoing description of the preferred embodiments of the present invention is by way of example only, and other variations and modifications of the above-described embodiments and methods are possible in light of the foregoing teaching. For example, each of the components in each of the figures need not be integrated into a single computer system. Each of the components may be distributed within a network. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A system, comprising:
a biometric capturing device configured for capturing biometric data of a person while the person is perceiving a product; and
a device for storing information based on the biometric data and information about the product.

2. The system of claim 1, wherein the product includes a video clip.

3. The system of claim 2, wherein the information about the product includes a video index.

4. The system of claim 1, wherein the information about the product includes the product.

5. The system of claim 1, wherein the biometric data includes at least one of primary biometric data and secondary biometric data.

6. The system of claim 1, wherein the biometric data includes at least one expression from the group of facial expressions, voice expressions, iris information, body language, perspiration levels, heartbeat information, unrelated talking, and related talking.

7. The system of claim 1, wherein the biometric capturing device includes at least one of a microphone, a camera, a thermometer, a heart monitor, and an MRI device.

8. The system of claim 7, wherein the biometric capturing device further includes a biometric expression recognizer.

9. The system of claim 1, wherein the information based on the biometric data includes at least one of primary biometric information, secondary biometric information, and reaction review metric information.

10. The system of claim 1, further comprising a decision mechanism and reaction integrator for interpreting biometric data as emotions.

11. The system of claim 1, further comprising an advertising estimator for estimating a cost of an advertisement based on the biometric data.

12. The system of claim 1, further comprising a reviewer for enabling another person to review the information based on the biometric data and the information about the product.

13. A method comprising:
capturing biometric information while a person perceives a product; and
storing information based on the biometric information and information about the product in a database for future consumption.

14. The method of claim 13, wherein the product includes a video clip.

15. The method of claim 14, wherein the information about the product includes a video index.

16. The method of claim 13, wherein the information about the product includes the product.

17. The method of claim 13, wherein the biometric data includes at least one of primary biometric data and secondary biometric data

18. The method of claim 13, wherein the biometric data includes at least one expression from the group of facial expressions, voice expressions, iris information, body language, biometric information, perspiration levels, heartbeat information, unrelated talking, and related talking.

19. The method of claim 13, wherein the information based on the biometric data includes at least one of primary biometric information, secondary biometric information, and reaction review metric information.

20. The method of claim 13, further comprising recognizing the biometric data as emotions and emotional levels.

21. The method of claim 13, further comprising estimating a cost of an advertisement based on the biometric data.

22. The method of claim 13, further comprising enabling another person to review the biometric information and the information about the product.

23. A system comprising:
means for capturing biometric information while a person perceives a product; and
a database for storing information based on the biometric information and information about the product for future consumption.

24. A content providing system comprising:
at least one device for presenting content to a user, for capturing biometric information of the user, and for sending the captured biometric information to a server; and
a server for storing the content and previously obtained biometric information corresponding to the content, for providing the content and the previously obtained biometric information to the at least one device, for receiving the captured biometric information of the user from the at least one device, and for updating the previously obtained biometric information based on the captured biometric information received from the at least one device.
